(19) United States
(12) Patent Application Publication
(10) Pub. No.: US 2026/0329369 A1
(43) Pub. Date: Oct. 22, 2026

(54) METHODS, ARCHITECTURES, APPARATUSES AND SYSTEMS FOR DATA-DRIVEN PREDICTION OF EXTENDED REALITY (XR) DEVICE USER INPUTS

(71) Applicant: InterDigital Patent Holdings, Inc., Wilmington, DE (US)

(72) Inventors: Renan Krishna, Brighton (GB); Satyanarayana Katla, London (GB)

(21) Appl. No.: 19/104,683

(22) PCT Filed: Aug. 17, 2023
(86) PCT No.: PCT/US2023/030466

§ 371 Date: Feb. 18, 2025

(30) Foreign Application Priority Data
Aug. 19, 2022 (EP) 22191237.1

(51) Int. Cl. G06F 3/01; G06N 3/08; G06T 19/00; H04L 65/1104; H04L 69/24; H04W 28/18

(52) U.S. Cl. CPC G06F 3/011; G06N 3/08; G06T 19/00; H04L 65/1104; H04L 69/24; H04W 28/18

(57) ABSTRACT

Procedures, methods, architectures, apparatuses, systems, devices, and computer program products implemented by a wireless transmit/receive unit (WTRU) comprises: obtaining, at a first time, first user input data; sending first information comprising neural network data generated from a first distributed deep neural network (DNN) of the WTRU; receiving second information comprising first predicted user input data generated from a second DNN of an edge device at a second time; obtaining, at the second time, second user input data; determining a first prediction error based on the first predicted user input data at the second time and on second user input data obtained at the second time; and sending on condition that the first prediction error is above a threshold value, third information comprising the first prediction error and/or an indication to trigger an error correction algorithm for predicting user input.

### CROSS-REFERENCE TO RELATED APPLICATIONS

This application claims the benefit of EP Patent Application No. 22191237.1 filed Aug. 19, 2022, which is incorporated herein by reference.

### BACKGROUND

The present disclosure is generally directed to the fields of communications, software and encoding, including, for example, to methods, architectures, apparatuses, systems related to data-driven prediction of XR device user inputs.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a relation between a response time on network latency;

FIG. 3 illustrates a relation between a user action prediction and low response time;

FIG. 4 illustrates an example architecture running on a WTRU;

FIG. 5 illustrates an example architecture running on an edge device.

FIG. 6 is a system diagram illustrating an example of 5G-XR functions integrated in a 5G system;

FIG. 7 is a system diagram illustrating an example of extension of functionality of a 5G system;

FIG. 8 is a more detailed view of the system diagram of FIG. 7;

FIG. 9 is a message sequence diagram for first exploring alternative solution spaces and then triggering an online re-training of a model on a Deep Neural Network (DNN);

FIG. 10 is a flow diagram illustrating a method implemented at WTRU according to one or more embodiments;

FIG. 11 is a further flow diagram illustrating a method implemented at an edge device according to one or more embodiments; and

FIG. 12 is a flow diagram illustrating another method implemented at WTRU according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

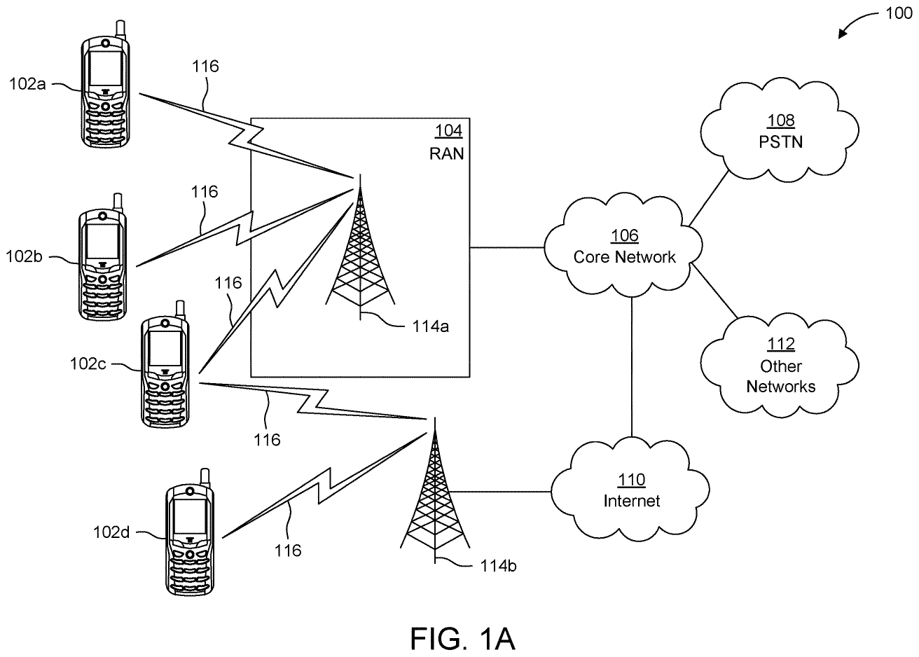

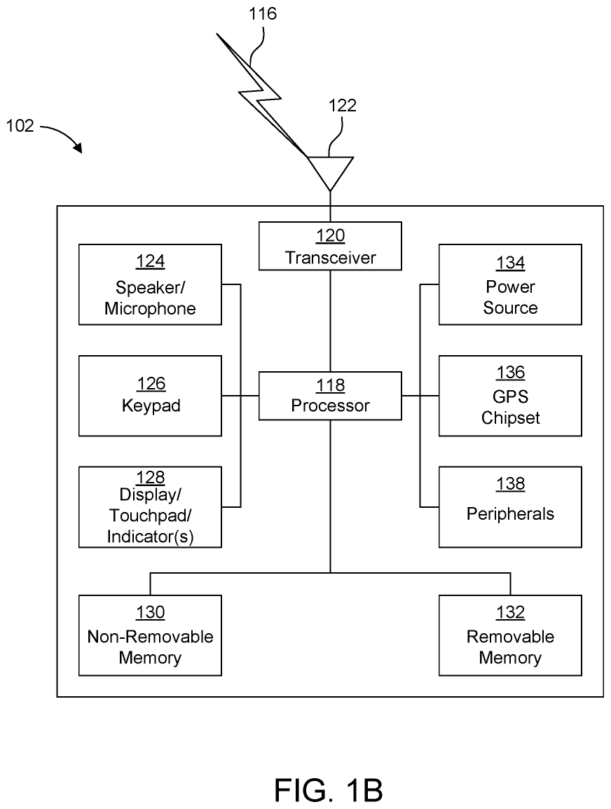

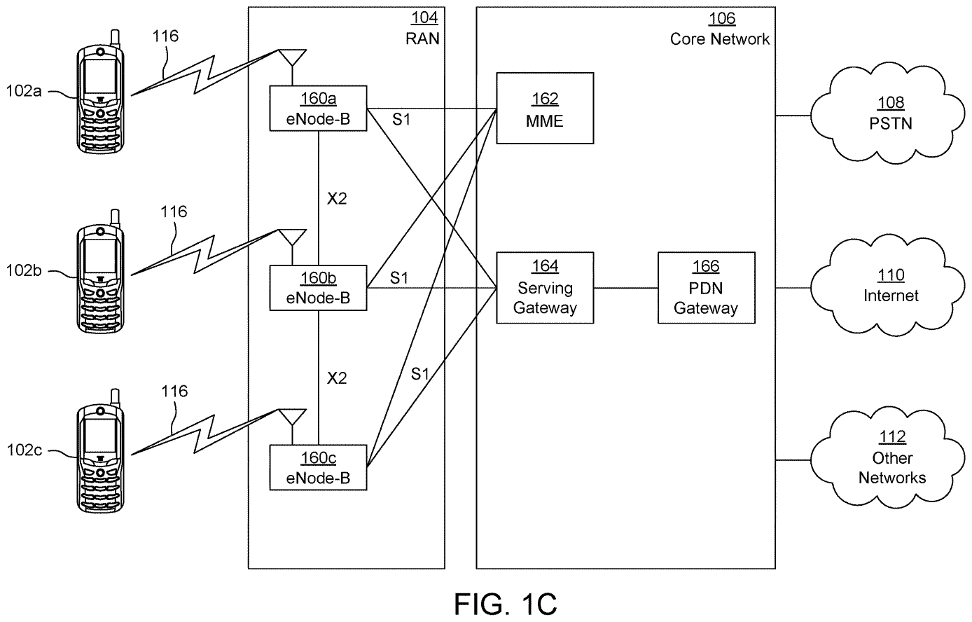

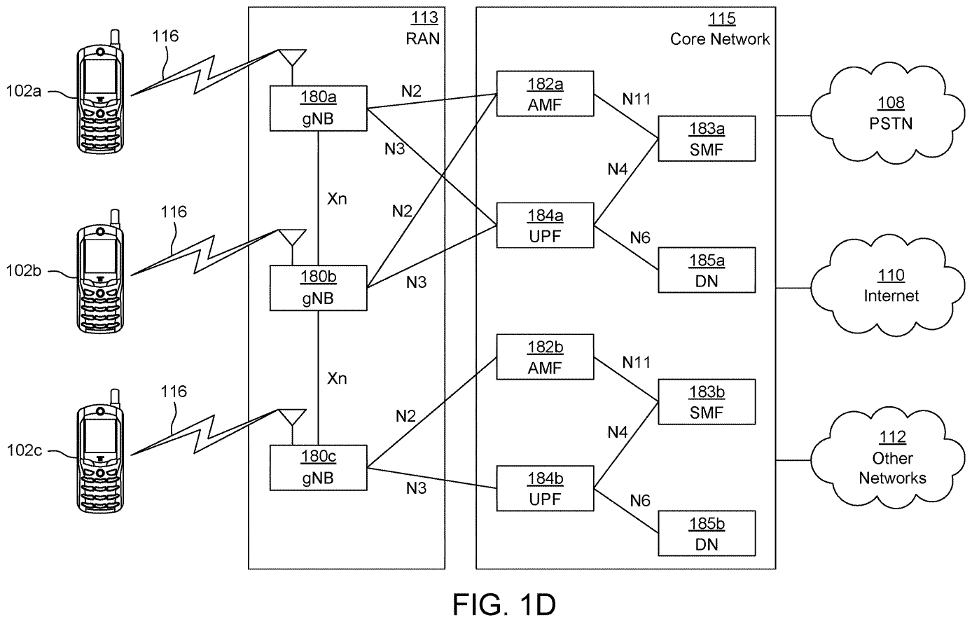

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Use Case for XR Applications

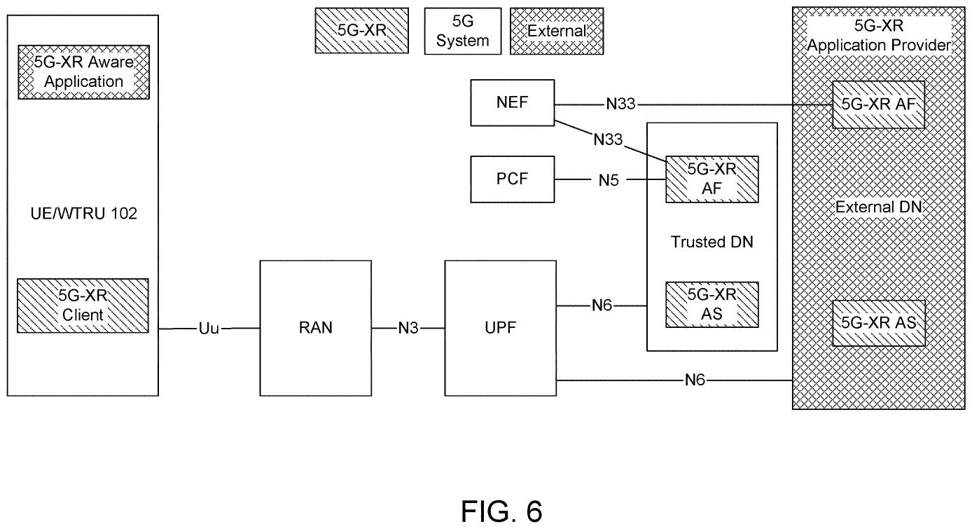

The 3GPP document TR 26.928 presents an architecture to support Extended Reality (XR) as shown in FIG. 6. XR is defined in that document as follows: “Extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them.”

In this disclosure, the definition of XR corresponds to the description above.

The Internet Engineering Task Force (IETF) Media Operations (MOPS) Working Group document has presented the following use case for an XR application:

“Consider a group of tourists who are being conducted in a tour around the historical site of the Tower of London. As they move around the site and within the historical buildings, they can watch and listen to historical scenes in 3D that are generated by the AR application and then overlaid by their AR headsets onto their real-world view. The headset then continuously updates their view as they move around.

The AR application first processes the scene that the walking tourist is watching in real-time and identifies objects that will be targeted for overlay of high resolution videos. It then generates high resolution 3D images of historical scenes related to the perspective of the tourist in real-time. These generated video images are then overlaid on the view of the real-world as seen by the tourist. The components of AR applications perform tasks such as real-time generation and processing of high-quality video content that are computationally intensive. As a result, on AR devices such as AR glasses excessive heat is generated by the chip-sets that are involved in the computation. Additionally, the battery on such devices discharges quickly when running such applications. A solution to the heat dissipation and battery drainage problem is to offload the processing and video generation tasks to the remote cloud. However, running such tasks on the cloud is not feasible as the end-to-end delays must be within the order of a few milliseconds. Additionally, such applications require high bandwidth and low jitter to provide a high Quality of Experience (QoE) to the user. In order to achieve such hard timing constraints, computationally intensive tasks can be offloaded to Edge devices.”

This use case may use (e.g., requires) computationally intensive algorithms to process scenes and generate videos in real-time. The computationally intensive tasks can be off loaded to the Edge. The response times and related issues with such offloading are described below.

The current XR applications are organized around a processing loop that starts with the WTRU (e.g., UE) sending the user's commands and ends with the XR platform running on the edge returning a resultant video frame. Assuming that the frames are being generated at a rate of 30 fps, the time taken to return the resultant frame is 33 ms (1/30 approximately)+the network latency between the WTRU (e.g., UE) and the XR system running on the edge. This may be (e.g., essentially) the response time that this XR system takes from when the user makes some kind of movement (say turns their head to look around) to when the corresponding frame is rendered on the user's device. This response time may be equal to or below the desired 100 ms to give a realistic display only if the time taken to generate the frame is equal to or below 33 ms and the network latency is equal to or below 67 ms. The response time without the overhead of network latency may be referred to as the frame time. The frame time may be 33 ms when we assume the frame rate to be 30 fps. The next section shows how predicting the user input can reduce the response time.

### Predicting User Input in XR Applications

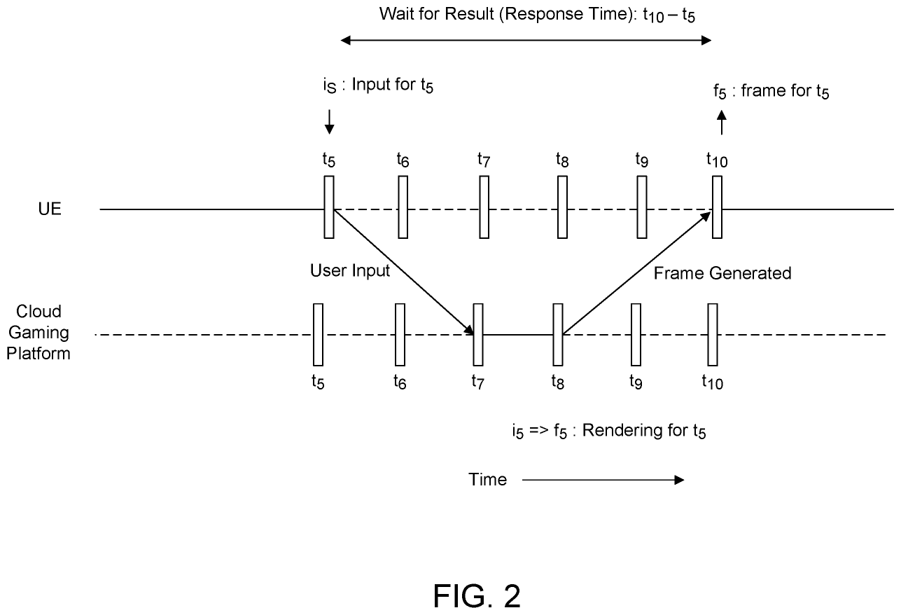

FIG. 2 illustrates how response time of an XR application such as cloud gaming may depend on latency when the user's input to the WTRU (e.g., UE) is not predicted but is simply processed by the cloud and sent back. Time is discretized for example at 33 ms (which is the frame time as defined above) per clock tick. At clock tick t5, the user's input i5 is sent to the server on the cloud. Assuming an RTT of 4 clock ticks (4×33=132 ms), the user input reaches the server after 2 clock ticks at t7. On the server, it takes one clock tick till t8 to generate the appropriate frame f5. This frame reaches the client 2 clock ticks later at t10 as shown in the figure. Thus, the total response time is 5 clock ticks which is 5×33=165 ms. The response time increases by the amount equal to RTT (4 clock ticks).

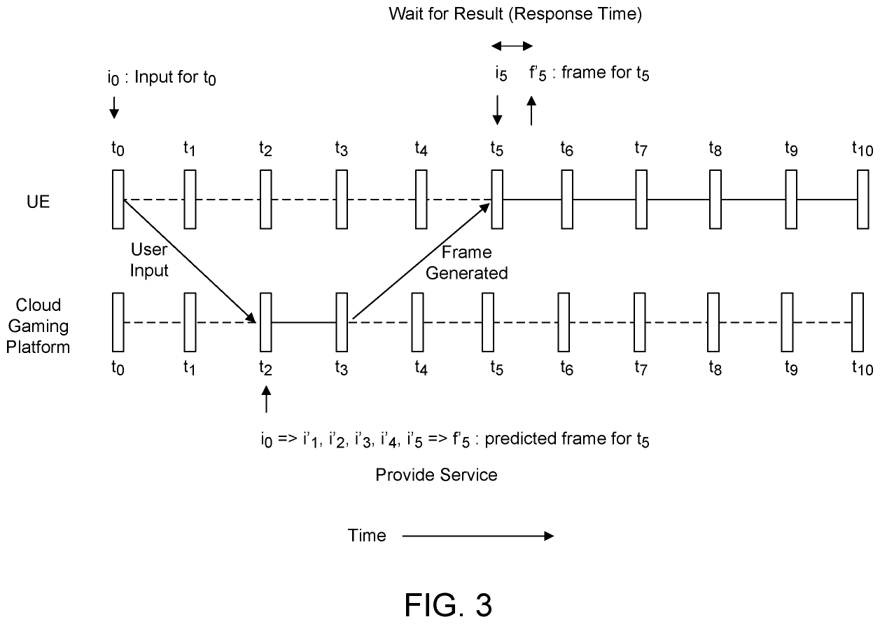

FIG. 3 illustrates how the effects of network latency can be mitigated by predicting user's actions in advance and generating the corresponding frame that is then sent to the WTRU (e.g., UE). Each clock tick in FIG. 3 corresponds to a discrete time of 33 ms. At t0, the user's input i0 is sent to the server. Assuming an RTT of 4 clock ticks, the input i0 reaches the server at time t2. The server then predicts the user input sequence for say 1 RTT in future and sends the predicted input i′5's corresponding frame f5 to the WTRU (e.g., UE). This predicted frame f5 is then rendered on the WTRU (e.g., UE) if the prediction is accurate. As shown in FIG. 3 the response time between i5 and f5 is now considerably reduced.

### Overview

### Architecture of the XR System Running on the WTRU (e.g., UE)

### Architecture of Components on the WTRU (e.g., UE)

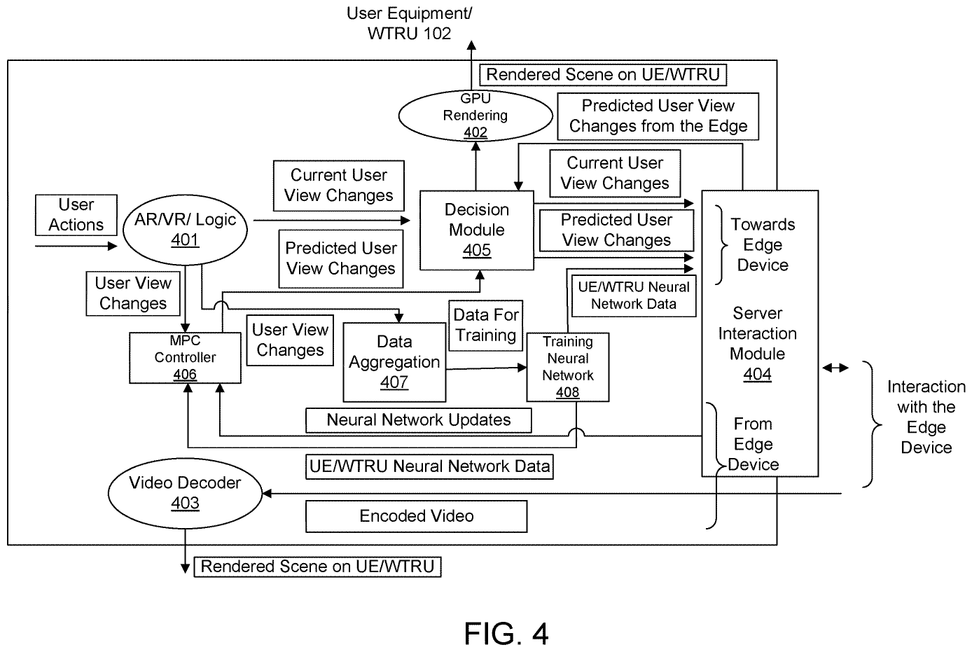

FIG. 4 illustrates the architecture of the proposed system that may be running on the User Equipment (UE) to deliver low latency to XR Applications.

The architecture as shown in FIG. 4 may comprise (e.g., be composed) of the following components whose inputs and outputs are discussed below:

AR/VR Logic 401: the “User Actions” by the user may be interpreted as changes in the user view by the “AR/VR Logic” module of the WTRU (e.g., UE). These changes can be carried as a data structure labelled “User View Changes” to the “Data Aggregation” or the “MPC Controller” module as shown in FIG. 4. In addition, these changes can be carried as a data structure labelled “Current User View Changes” in FIG. 4 to the “Decision Module”.

GPU Rendering 402: this component's one input can be “Current User View Changes” carried in a data structure as shown in FIG. 4. This data may be forwarded by the “Decision Module” and may be originally coming from the “AR/VR Logic” module on WTRU (e.g., UE). Another input can be “Predicted User View Changes” carried in a data structure and forwarded by the “Decision Module”. FIG. 4 shows that this second input can come from the “MPC Controller” component either on the WTRU (e.g., UE) or on the Edge device. This “GPU Rendering” component may convert those data structures into appropriate video frames as an output.

Video Decoder 403: this module can receive an “Encoded Video” Stream from the network and can decompress it in a video frame format appropriate for rendering a scene on the WTRU (e.g., UE) as shown in FIG. 4.

Server interaction Module 404: this module may provide services that include but are not limited to marshalling arguments into byte arrays and un-marshalling the byte array replies back into a suitable data format, providing authentication services, naming and directory services, programming abstractions etc.

Decision Module 405: this module can accept as an input “Current User View Changes” carried in a data structure from the “AR/VR Logic” component on WTRU (e.g., UE) as shown in FIG. 4. In addition, as FIG. 4 shows, it can accept “Predicted User View Changes” carried in a data structure from either the “MPC Controller” component of WTRU (e.g., UE) or “MPC Controller” of the Edge device. For example, depending on the decision algorithm, both the “Current User View Changes” data structure and the “Predicted User View Changes” data structure can be output into the “GPU Rendering” module and/or a call can be made to “Server Interaction Module's procedures.

In one embodiment, the decision algorithm on the Decision Module may select any of the following combination of choices: (a) Use low quality video rendering by WTRU's (e.g., UE's) GPU Rendering module+use low quality prediction by WTRU's (e.g., UE's) DNN; (b) Use low quality video rendering by WTRU's (e.g., UE's) GPU Rendering module+use high quality prediction by Edge device's DNN; (c) Use low quality prediction by WTRU's (e.g., UE's) DNN+use high quality video rendering by Edge device's GPU rendering module; (d) use high quality video rendering by Edge device's GPU rendering module+use high quality prediction by Edge device's DNN.

This choice may be made in coordination with the Decision Module on the Edge device on the basis of an exchange of telemetry data. In one embodiment, the telemetry data could be the Round-trip time (RTT) between the WTRU (e.g., UE) and the Edge device.

MPC Controller 406: this module runs a Model-Predictive-Controller (MPC) algorithm which may be a (e.g., classical) control policy. It may take predictions labelled “UE Neural Network Data” from the Deep Neural Network (DNN) trained predictor labelled “Trained Neural Network” in FIG. 4 (in one embodiment, this prediction could be a point estimate whereas in another embodiment, it could be a probability distribution). These predictions can be used as an input to optimize an objective QoE function. In one embodiment, the QoE may be a function of the round-trip time (RTT). The MPC Controller can get updates of the user's moves, for example, as current “User View Changes” from the “AR/VR Logic” module. The final input can be updated to the numerical parameters of the control algorithm from the Edge device's MPC Controller labelled “Neural Network Updates” in FIG. 4. The output of the MPC Controller may be a data structure carrying the “Predicted User View Changes” that can be sent to the “Decision Module”.

Data Aggregation 407: this module can collect “User View Changes” carried in a data structure from the WTRU's (e.g., UE's) “AR/VR Logic” module and may use this data to train the DNN labelled “Trained Neural Network” as shown in FIG. 4. In one embodiment, this training may be done once a day.

Trained Neural Network 408: this component may be a (e.g., small) DNN that can be run on a UE. Because of its (e.g., small) size, this DNN may (e.g., only) produce approximate predictions based on the inputs from the “Data Aggregation” module of the WTRU (e.g., UE) discussed above. Its output may be a prediction of the future state of the user's inputs in the environment. In one embodiment, the predictions may be in the form of a point estimate. In another embodiment, the predictions may be in the form of a probability distribution. These approximate predictions labelled “UE Neural Network Data” in FIG. 4 may be used on the WTRU (e.g., UE) itself by the MPC Controller. It may be sent to the Edge device using the “Server Interaction Module” procedures.

### Architecture of the Components Running on the Edge

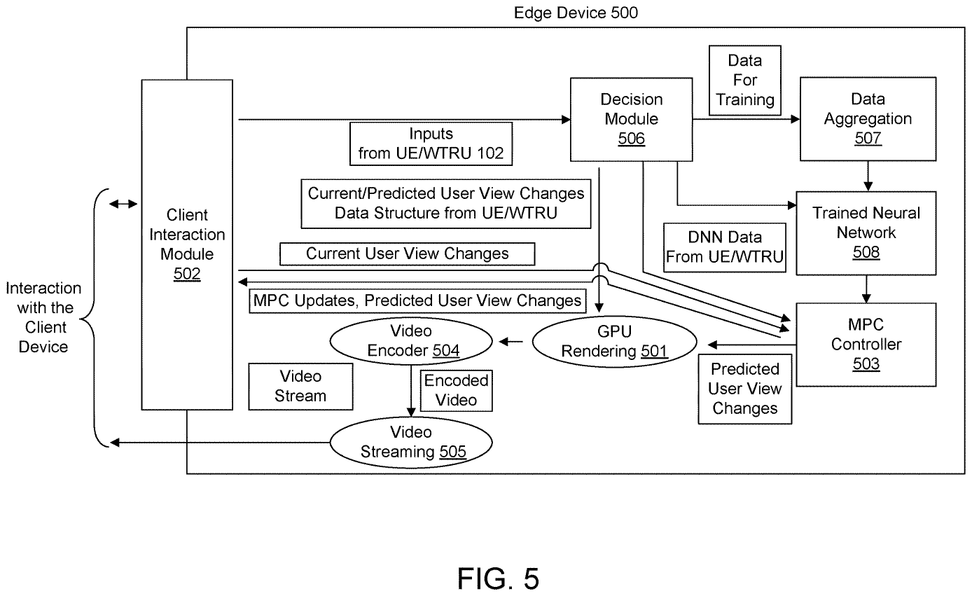

FIG. 5 shows the components running on the Edge device 500. This architecture may comprise (e.g., be composed) of the following components whose inputs and outputs are discussed below:

GPU Rendering 501: its input can be a data structure carrying “Changes in the User View” or a data structure carrying “Predicted User View Changes” from the Edge's “Decision Module” and originally coming from WTRU (e.g., UE) (labelled as “Current/Predicted User View Changes” in FIG. 5). Another input can be a data structure carrying “Predicted User View Changes” from the Edge's “MPC Controller” and triggered by the Edge's “Decision Module”. The “GPU Rendering” module can convert the data structures into appropriate video frames as an output into the “Video Encoder” component of the Edge.

Client Interaction Module 502: this component may get its inputs from the UE. These inputs may fall into three categories: “Current User View Changes”, “Predicted User View Changes”, and “UE Neural Network Data”. This “Client Interaction module” can then forward these inputs to the “Decision Module”. The “Current User View Changes” can also be forwarded to the Edge's “MPC Controller”. The “Client Interaction Module” may provide services that include but are not limited to marshalling arguments into byte arrays and un-marshalling the byte array replies back into a suitable data format, authentication services, naming and directory services, programming abstractions etc.

MPC Controller 503: this module may run a, for example Model-Predictive-Controller (MPC), algorithm which may be a classical control policy. It may take predictions labelled “DNN data from UE” in FIG. 5 from the DNN trained predictor “Trained Neural Network” on the WTRU (e.g., UE) (FIG. 4) which may be a low quality prediction. It may take predictions as shown in FIG. 5 from the DNN trained predictor “Trained Neural network” on the Edge device which combines the low quality prediction from WTRUs (e.g., UEs) “Trained Neural Network” with Edge's own “Trained Neural Network”. The decision to choose the prediction input from these two choices may be made by the “Decision Module” on the Edge device discussed below.

In one embodiment, this prediction could be a point estimate whereas in another embodiment, it could be a probability distribution) as an input to optimize an objective QoE function. In one embodiment, the QoE may be a function of the RTT.

As shown in FIG. 5 the MPC Controller can get updates of the user's view as “Current User View Changes” carried in a data structure from the “AR/VR Logic” module on the WTRU (e.g., UE) and sent to the Edge device's “Server Interaction Module” from WTRU's (e.g., UE's) “Client Interaction Module”.

One output of an MPC Controller can be a data structure carrying the “Predicted User View Changes” that may be sent to the “GPU Rendering” component on the Edge device as shown in FIG. 5. The second output can be updated to the numerical parameters of the control algorithm from the Edge device's “MPC Controller” to the WTRU's (e.g., UE's) “MPC Controller”. The final output can be a data structure carrying “Predicted User View Changes” that may be sent to the WTRU (e.g., UE) via a procedure of the Edge's “Client Interaction Module” as shown in FIG. 5.

Video Encoder 504: its input can be appropriate video frames to be compressed from the “GPU Rendering” module of the Edge. Its output can be a set of compressed video frames using an appropriate encoding.

Video Streaming Module 505: this component's input can be a set of compressed video frames using an appropriate encoding. Its output can be a video stream appropriate for transport over the network.

Decision Module 506: this module can accept the following inputs from the “Client Interaction Module” of the Edge device: The first input can be “Current User View Changes” carried in a data structure from the WTRU (e.g., UE), the second input can be “Predicted User View Changes” carried in a data structure and the third input that can be accepted may be the “WTRU (e.g., UE) Neural Network Data” which in one embodiment could be a point estimate and in another a probability distribution.

The outputs may be as follows: The module can forward the “Current User View Changes” as a data structure carrying status updates to the “GPU Rendering” module or the “Data Aggregation” module; The module can also forward “Predicted User View Changes” carried in a data structure to the “GPU Rendering” module on the Edge Device. Another output can be the “DNN Data from UE” (which in one embodiment could be a point estimate and in another a probability distribution) to the DNN labelled “Trained Neural Network” in FIG. 5. This same “DNN Data from UE” can also be forwarded to the “MPC Controller” component on the Edge Device as shown in FIG. 5.

In one embodiment, the decision algorithm on the Decision Module selects any of the following combination of choices: (a) Use low quality video rendering by WTRU's (e.g., UE's) GPU Rendering module+use low quality prediction by WTRU's (e.g., UE's) DNN; (b) Use low quality video rendering by WTRU's (e.g., UE's) GPU Rendering module+use high quality prediction by Edge device's DNN; (c) Use low quality prediction by WTRU's (e.g., UE's) DNN+use high quality video rendering by Edge device's GPU rendering module; (d) Use high quality video rendering by Edge device's GPU rendering module+use high quality prediction by Edge device's DNN. This choice may be made in coordination with the Decision Module on the WTRU (e.g., UE) on the basis of an exchange of telemetry data. In one embodiment, the telemetry data could be the Round-trip time (RTT) between the WTRU (e.g., UE) and the Edge device.

Data Aggregator 507: this module can collect current user view changes labelled as “Data for Training” in FIG. 5 and carried in a data structure from the Edge device's “Decision Module”. It can use this data to train the DNN labelled “Trained Neural Network” in FIG. 5. In one embodiment, this training may be done once a day.

Trained Neural Network 508: this may be a DNN with the following inputs: the first input can be data for training the DNN from the “Data Aggregator” 507 as discussed above. In one embodiment, this training may be done once a day. The second input can be “DNN Data from UE” forwarded by the “Decision Module” as shown on FIG. 5. This second input originally coming from the WTRU's (e.g., UE's) (e.g., smaller) DNN in one embodiment could be an approximate point estimate and in another an approximate probability distribution. The output of this DNN may be a prediction which in one embodiment could be an accurate point estimate and in another an accurate probability distribution.

### Mapping of the WTRU (e.g., UE) and Edge Components to 3GPP Architecture

3GPP specification (for example TR 26.928), may present an architecture to support Extended Reality (XR) as shown in FIG. 6.

The AR/VR low-latency requirements are discussed in this document.

This section presents an architecture to extend the 3GPP proposals.

In FIG. 6, the “5G-XR” client may be the receiver of 5G-XR session data that may be accessed through well-defined interfaces/APIs by the 5G-XR Aware Application. This client accesses the 5G-XR AF through the X5 interface (as shown in FIG. 6). This 5G-XR AF may be an Application Function similar as defined in 3GPP specification (for example TS 23.501, clause 6.2.10), dedicated to 5G-XR Services. In addition, the 5G-XR client accesses 5G-XR AS through the X4 interface (as shown in FIG. 6). 5G-XR AS may be an Application Server dedicated to 5G-XR Services.

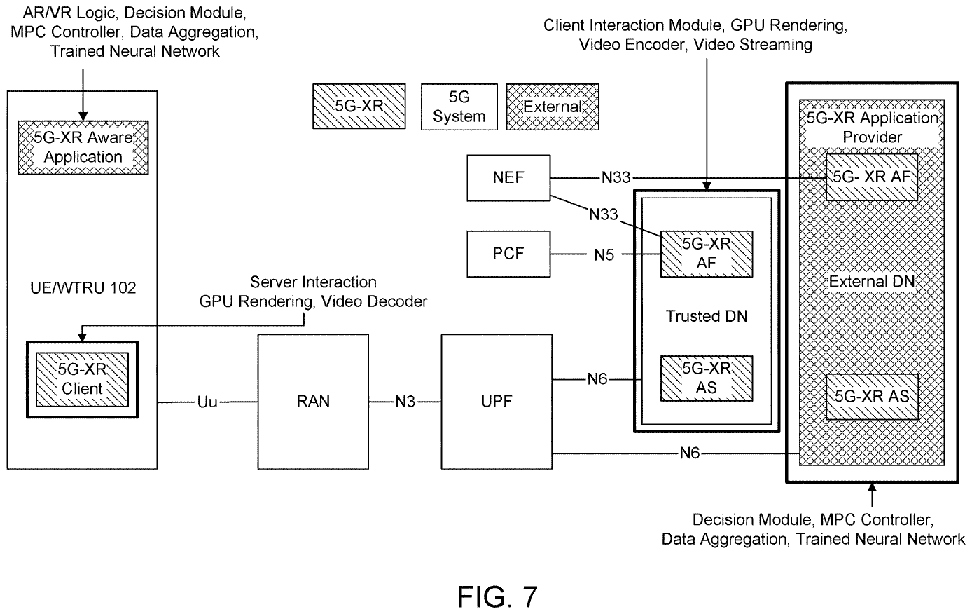

FIG. 7 shows how the described components may be used to extend the functionality of the architecture proposed by the 3GPP specification (for example TR 26.928). The “5G-XR Client” can be extended by including “Server Interaction Module”, “GPU Rendering”, and “Video Decoder” components of FIG. 4.

According to 3GPP specification (for example TR 26.928), AI components may be considered specific to the particular XR applications for which they may be created. As a result, as shown in FIG. 7, “MPC Controller”, Data Aggregation” and “Trained Neural Network” can be part of the 5G-XR Application in this embodiment. “AR/VR Logic” and the “Decision Module” may also be a part of the application.

The Trusted DN (Data Network) module may play the role of “Client Interaction Module” as shown in FIG. 7. In addition, the “GPU Rendering”, “Video Encoder” and “Video Streaming” may be a part of the trusted DN in this embodiment.

“Decision Module”, “MPC Controller”, “Data Aggregation”, and “Trained Neural Network” components can extend the functionality of the 5G-XR Application Provider's “External Data Network (DN)” as shown in FIG. 7.

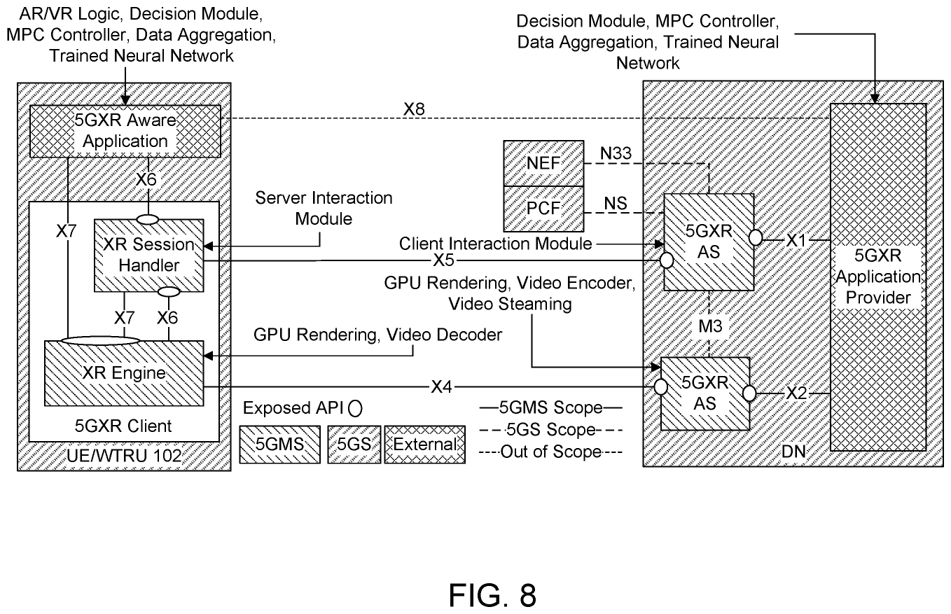

FIG. 8 is a more detailed view of the system diagram of FIG. 7. The “XR Engine” in the 3GPP architecture can play the role of “GPU Rendering” and “Video Decoder”. The “XR Session Handler” can play the role of the “Server Interaction Module”. Finally, the “5GXR Aware Application” can embody the components “AR/VR Logic”, “Decision Module”, “MPC Controller”, “Data Aggregation”, and “Trained Neural Network”.

On the server side as shown in FIG. 8, the “5G XR AS” module can embody the components “GPU Rendering” and “Video Encoder” and “Video Streaming”; the “5G XR AF” module can embody the “Client Interaction Module” and finally the “5GXR Application Provider” module can embody the components “Decision Module”, “MPC Controller”, “Data Aggregation”, and “Trained Neural Network”.

Although the embodiment in FIGS. 6-8 focuses on 5G networks, the proposed ideas in this disclosure can be similarly applied to beyond 5G and 6G cellular networks.

Unique AI model in the WTRU (e.g., UE)/edge nodes

Using a unique AI model in the WTRU (e.g., UE)/edge nodes may not provide the better KPI because of heavy-tailed WTRU (e.g., UE) input distribution.

Due to the heavy tailed nature of parameters such as network bandwidth, buffer occupancy the predictions using offline models for XR applications may be inaccurate. This may be because for such heavy-tailed distributions, the law of large numbers (LLN) may work too slowly to be of any practical use, or LLN may not converge as the distribution that data may be drawn may not have definite mean (or variance).

The LLN says that the sample mean approaches population means as the number of samples becomes larger. This is mathematically expressed as

$${μ}_{s} = \frac{{X}_{1} + {X}_{2} + … + {X}_{N}}{N} ,$$

where the samples X₁, X₂, . . . , X_{N} may be drawn from distribution with finite mean μ (population mean) and variance (population/true variance). Then as the number of samples N becomes larger, the sample mean us becomes population mean μ.

The LLN relies on the assumption that the source distribution has finite mean and variance, which may not be the case for real world data which obey heavy-tailed distribution, such as the user input data distribution discussed in the disclosure.

The problem with such distributions, i.e., heavy-tailed, may be that mean of sample and the ground truth mean value the probability distribution of the data may not be equal as a result of which the sample mean, and variance cannot be used or relied upon as inputs for computing predictions. This may be captured mathematically by LLN. Moreover, such distributions may suffer from “expectation paradox” where the duration of the future occurrence of an event may be proportional to the time elapsed (elapsed duration) for a past occurrence of the same event.

This problem may be solved by observing the whole data set for making accurate predictions. This may not be realizable in practice for the use cases discussed in this disclosure. Therefore, any unseen data (e.g., an outlier) arising in real-time may distort the prediction.

### Trigger Condition(s) for the Online (Re)Training of the Models Running on DNN in the WTRU (e.g., UE) Running an XR Application and the Edge

Current systems re-train their models running on a DNN once every day. However, since the user's input to the XR device as they move around may be heavy-tailed, the models running on the DNN typically may become outdated as the past user input cannot be used to predict future user input.

The environment in which the XR device may be running may suffer from failures in edge devices and communication links, variations in the characteristics of communication such as bandwidth, and the creation and destruction of logical communication relationships between software components running on the WTRU (e.g., UE) and the Edge. This high volatility in the environment may be another source of the failure of predictions as the DNN data arrival rates at both the WTRU (e.g., UE) and the Edge may be heavy-tailed in nature and might fail to accurately match the current user action.

In other words, the real time data of the user significantly differs from the data used for DNN training, which may be employed offline. In this event, the DNN may not be able to predict the user's future move accurately. Therefore, retraining (may be employed online) of the DNN weights based on the observed real data set may be used (e.g., required), where the DNN weights may be updated. Since the retraining/recalibrating of DNN weights may happened on the pre-trained DNN, the overhead involved in the online retraining/recalibrating of DNN would be significantly lower when compared to that of online training when DNN may be in tabula rasa state.

### Frequency of the Training

In current systems, the frequency at which the models running on a DNN need to be updated (for example once a day) may be independent of the dynamic nature of the user's behavior and the environment. However, because of the heavy-tailed nature of the user input to XR devices, these models get outdated quickly. This results in mis-prediction of the user input that needs to be mitigated by frequent updates. However, the current architecture may not have a way to deal with this frequent requirement to update the models running on DNN. Mechanisms may be needed such that some prediction error may be corrected without re-training the model whereas more severe errors result in re-training.

The update or retraining of the DNN may be employed in any of the following ways: periodic, semi-persistent and aperiodic mechanisms-all of which require large overhead and should be invoked as a last resort.

### Representative Procedures and Embodiments

The following section describes one or more embodiments addressing the problem where a unique AI model running on the WTRU (e.g., UE) and the Edge that may be used to predict future user actions gets out-of-date resulting in prediction errors. This may be due to the fact that the user input at the WTRU (e.g., UE) follows a heavy-tailed distribution as discussed in the section above.

The following section describes one or more embodiments addressing the trigger condition(s) for the online (re) training of machine learning in the WTRU (e.g., UE) running XR application.

According to an embodiment, it may involve a step-by-step escalation of the mechanism used to improve the accuracy of the prediction culminating in an agreement between the WTRU (e.g., UE) and the Edge on re-training of their DNNs, for example, at a mutually acceptable time. That is to say if the predicted user inputs are deviating too much from the actual user inputs, the embodiment may use the following algorithm:
i. Firstly, the UE-Edge distributed system may use a mutually agreed standard algorithm for error correction.
ii. If error correction fails, it may use a shorter time horizon for prediction using the existing model.
iii. In a case where (e.g., only) the usage of a shorter time horizon fails to produce accurate prediction, a proposed mechanism may decide to trigger re-learning.

According to the embodiment, it provides a mechanism that may (e.g., first) explore alternative solution spaces and/or trigger the online re-training of the model on the DNN.

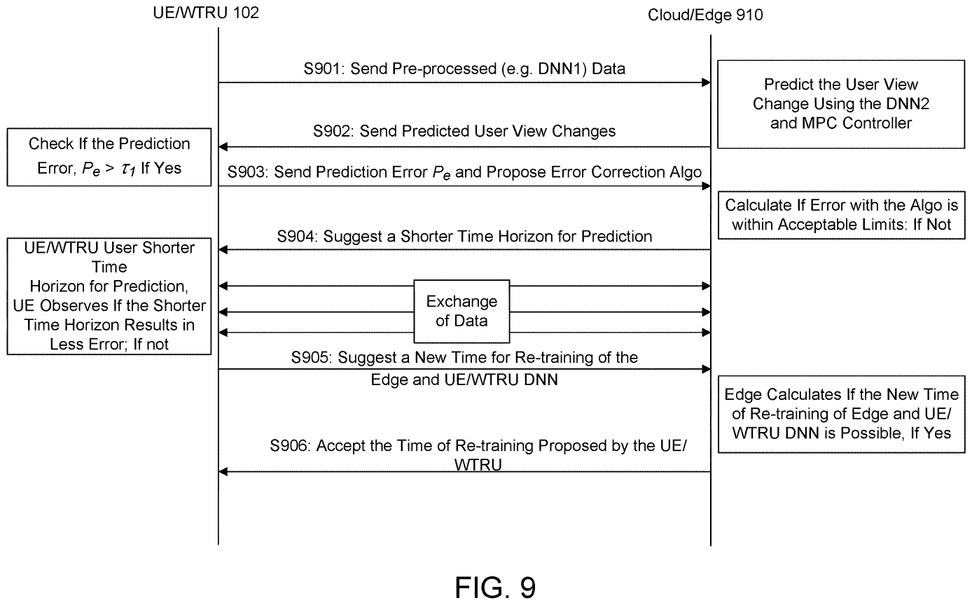

FIG. 9 describes a mechanism in the form of a message sequence diagram.
1. (S901) The WTRU 102 (e.g., UE) may send pre-processed data from its DNN to the Edge 910. This may be the early exit data that may be used by the Edge's DNN for further processing and (e.g., then) forwarded to the MPC controller for prediction on the edge device. This prediction could be a point estimate or a probability distribution.
2. (S902) The Edge device 910 may predict the user change view using the Edge's DNN and/or MPC Controller, for example, by passing to them the early exit data sent by the UE. The edge may send the prediction of user view changes to the WTRU 102 (e.g., UE).
3. (S903) The WTRU 102 (e.g., UE) may check if the prediction error Pₑ>τ₁ that is whether the error is above a threshold value. If the error is above the threshold value, the WTRU (e.g., UE) may send (signals) a message to the Edge proposing an error correction algorithm—examples of these algorithms include but may be not limited to Kalman Filtering, Partial Cube rendering, Depth Map Rendering.
4. (S904) The Edge device 910 may calculate/determine if after the running of one of the error correction algorithms proposed by the WTRU 102 (e.g., UE), the error is still above a threshold value. If that is the case, the Edge device 910 may send a message to the WTRU 102 (e.g., UE) suggesting a shorter time horizon of prediction for a more accurate prediction.
5. (S905) The WTRU 102 (e.g., UE) may observe/monitor the exchange of data to determine if the shorter time horizon proposed by the Edge device 910 results in an error that may be within the QoS requirement of the user. If not, the WTRU 102 (e.g., UE) may configure the time for re-training the DNN on the WTRU 102 (e.g., UE) and the Edge device 910.
6. (S906) The Edge device 910 may agree (sends ACK) to the configured time from the WTRU 102 (e.g., UE) in a message.

The described mechanism may ensure that re-learning of the model running on the DNN on WTRU 102 (e.g., UE) and Edge 910 may be (e.g., only) triggered when other mitigating mechanisms such as error correction algorithms and using a shorter horizon for prediction do not improve the prediction accuracy. The triggering of re-learning in the proposed embodiment may be dependent on how dynamic the environment may be rather than being done once a day. In other words, the triggering of re-learning of the DNN adapts to the time-varying conditions of the environment.

The following section describes one or more embodiments addressing the frequency of the training.

The mechanism discussed in FIG. 9 in the previous section may support aperiodic frequency of re-training of the model running on the DNN. More explicitly, the WTRU (e.g., UE) may trigger the retraining of the DNN model weights, for example, based on the observed variability of conditions in the environment.

In the current architectures, the retraining of the DNN model weights may be employed periodically regardless of the observed variation of the conditions in the environment. This may impose unnecessary overhead (sending training data) if the conditions in the environment are already congenial to the UE-Edge pair.

In the current architectures, the retraining of the DNN model weights may be employed in a semi-persistent fashion, where the WTRU (e.g., UE) may activate the retraining of the DNN aperiodically. In the case where the WTRU (e.g., UE) has activated the retraining, the DNN retraining may take place periodically as described above. The WTRU (e.g., UE) may choose to deactivate the DNN model based on the conditions in the environment. More explicitly, in semi-persistent re-training design, the WTRU (e.g., UE) may activate/deactivate the retraining aperiodically, while the retraining itself happens periodically. Thus, semi-persistent may be a combination of aperiodic activation and periodic training. FIG. 9 shows that the proposed embodiments can be used to implement a scenario where the WTRU (e.g., UE) and the Edge may (e.g., need to) dynamically agree on the re-training of the model running on the DNN, for example, in the face of varying wireless conditions and the fluctuations in the user's movement resulting in a heavy-tailed input to the XR device.

The initial approach of running error correction algorithm on the edge may ensure that if the error may be within a threshold, it may safely avoid re-training in order to get accurate predictions. This may be important because the errors in prediction arise because of a heavy-tailed user input which might result in a large number of minor errors along with a small number of very large errors. For the large number of minor errors, running an error correction algorithm may be sufficient.

However, for some number of errors, the error correction algorithm may be not sufficient. In those cases, predicting over a shorter time horizon may be sufficient to mitigate the effects of those errors.

The model running on the DNNs on the WTRU (e.g., UE) and Edge encapsulating the user behavior can become completely inadequate for prediction as the probability distribution being used in the model does not match the probability distribution of users' behavior. This may use (e.g., necessitate) re-training of the model as a final resort, for example, as implemented in step S906 of FIG. 9.

The mechanism presented in FIG. 9 supports an aperiodic frequency of re-training to deal with the heavy-tailed nature of the user's inputs.

### Extension to the Session Description Protocol (SDP)

The fields and data of the message exchanges of FIG. 9 can be mapped to SDP “Offer” procedure's capability negotiation parameters, for example, contained in the Session Initiation Protocol (SIP) protocol's UPDATE method.

To add new capabilities to SDP, a new attribute type “a=” at the session level may be defined. Attributes at the session level may be listed before the first media line in SDP.

The following section shows a set of proposed new SDP offer procedure's capability attribute:

The novel message for step S901 can be sent as the following new SDP offer procedure's capability attribute:
a=dnn_data: parameter1 parameter2 . . . parameterN
   Here “a=dnn_data:” is the new attribute representing DNN data that has multiple parameters separated by space.

The novel message for step S902 can be sent as the following new SDP offer procedure's capability attribute:
a=predict: point_est: value prob_dist: parameter1 parameter2 . . . parameterN

Here “a=predict:” is the new attribute representing the prediction that has multiple parameters separated by space. In this proposal, the first parameter “point_est:” represents the label for a point estimate prediction and has the parameter called “value”. The next parameter “prob_dist:” represents the label for a probability distribution prediction and can have multiple parameters separated by space.

The novel message for step S903 can be sent as the following new SDP offer procedure's capability attribute:
a=predict_error: parameter1 parameter2 . . . parameter
   Here “a=predict_error:” is the new attribute representing prediction error that has multiple parameters separated by space.

The novel message for step S904 can be sent as the following new SDP offer procedure's capability attribute:
a=predict_time_horizon: parameter1 parameter2 . . . parameter
   Here “a=predict_time_horizon:” is the new attribute representing a proposed time horizon for prediction that has multiple parameters separated by space.

Finally, the novel message for step S905 can be sent as the following new SDP offer procedure's capability attribute:
a=retrain_time: parameter1 parameter2 . . . parameter
   Here “a=retrain_time:” is the new attribute representing the time at which the DNN needs to be retrained and has multiple parameters separated by space.

### Example Implementation(s)

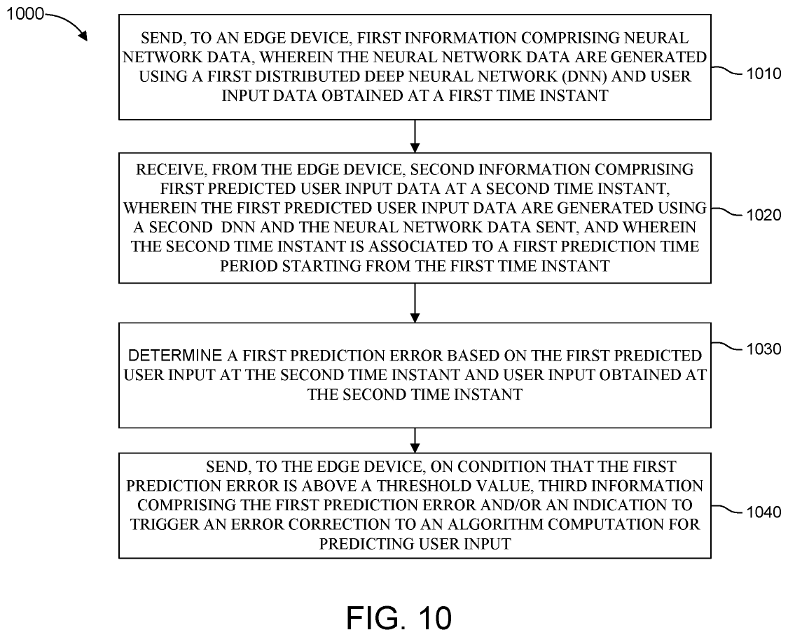

It is envisioned that the methods previously described herein may be combined in various ways. For example, referring to FIG. 10, a method of wireless communication 1000 implemented by a WTRU 102 begins at a first step 1010 in which the WTRU send, to an edge device 910, first information comprising neural network data, wherein the neural network data are generated using a first DNN and user input data obtained at a first time instant. Processing may proceed from step 1010 to a second step 1020.

At step 1020, the WTRU 102 may receive, from the edge device 910, second information comprising first predicted user input data at a second time instant, wherein the first predicted user input data are generated using a second DNN and the neural network data sent, and wherein the second time instant is associated to a first prediction time period starting from the first time instant. Processing may proceed from step 1020 to a third step 1030.

At step 1030, the WTRU 102 may determine a first prediction error based on the first predicted user input at the second time instant and user input obtained at the second time instant. Processing may proceed from step 1030 to a fourth step 1040.

At step 1040, the WTRU 102 may send to the edge device 910, on condition that the first prediction error is above a threshold value, third information comprising the first prediction error and/or an indication to trigger an error correction to an algorithm computation for predicting user input.

In certain representative embodiments, the WTRU 102 may receive, from the edge device 910, fourth information comprising a second prediction time period, wherein the second prediction time period is shorter than the first prediction time period; and may determine a second prediction error based on a second predicted user input predicted at a third time instant and further user input obtained at the third time instant, wherein the third time instant is associated to the second prediction time period.

In certain representative embodiments, the WTRU 102 may send, to the edge device 910, on condition that the second prediction error is above the threshold value, fourth information comprising a fourth time instant for retraining the first DNN and the second DNN; may receive, from the edge device 910, an acknowledgement message on the fourth time instant for retraining the first DNN and/or the second DNN; and may retrain the first DNN at the fourth time instant.

In certain representative embodiments, any of the first information, the second information, the third information, and the fourth information use an SDP.

In certain representative embodiments, any of the first information, the second information, the third information, and the fourth information are mapped to SDP offer procedure capability negotiation parameters.

In certain representative embodiments, the WTRU 102 any of the first information, the second information, the third information, and the fourth information use a SIP update function.

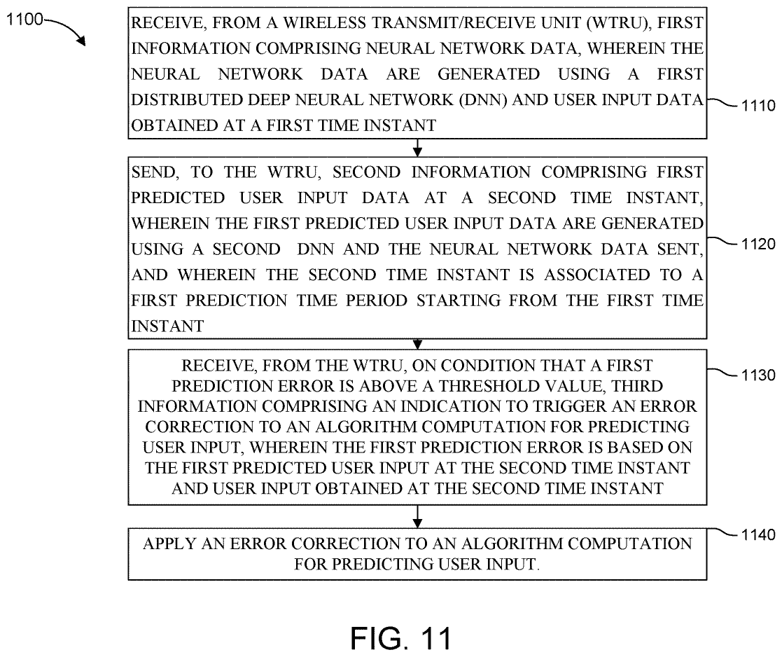

FIG. 11 is a flowchart illustrating an exemplary procedure 1100 implemented by an edge device 910.

Referring to FIG. 11, the representative method may include, at block 1110, receiving, from a WTRU 102, first information comprising neural network data, wherein the neural network data are generated using a first distributed DNN and user input data obtained at a first time instant. At block 1120, the edge device 910 may send, to the WTRU 102, second information comprising first predicted user input data at a second time instant, wherein the first predicted user input data are generated using a second DNN and the neural network data sent, and wherein the second time instant is associated to a first prediction time period starting from the first time instant. At block 1130, the edge device 910 may receive, from the WTRU 102, on condition that a first prediction error is above a threshold value, third information comprising an indication to trigger an error correction to an algorithm computation for predicting user input, wherein the first prediction error is based on the first predicted user input at the second time instant and user input obtained at the second time instant. At block 1140, the edge device 910 may apply an error correction to an algorithm computation for predicting user input.

In certain representative embodiments, the third information comprises the first prediction error and/or applying an error correction to the algorithm computation for predicting user input is based on the first prediction error.

In certain representative embodiments, the edge device 910 may send, to the WTRU 102, fourth information comprising a second prediction time period, wherein the second prediction time period is shorter than the first prediction time period.

In certain representative embodiments, the edge device 910 may receive, from the WTRU 102, on condition that a second prediction error is above the threshold value, fourth information comprising a fourth time instant for retraining the first DNN and the second DNN, for example, wherein the second prediction error is determined based on a second predicted user input predicted at a third time instant and further user input obtained at the third time instant, for example, wherein the third time instant is associated to the second prediction time period; the edge device 910 may send, to the WTRU 102, an acknowledgement message on the fourth time instant for retraining the first DNN and/or the second DNN; and the edge device 910 may retrain the second DNN at the fourth time instant.

In certain representative embodiments, any of the first information, the second information, the third information, and the fourth information use an SDP.

In certain representative embodiments, any of the first information, the second information, the third information, and the fourth information are mapped to SDP Offer procedure capability negotiation parameters.

In certain representative embodiments, any of the first information, the second information, the third information, and the fourth information use a SIP update function.

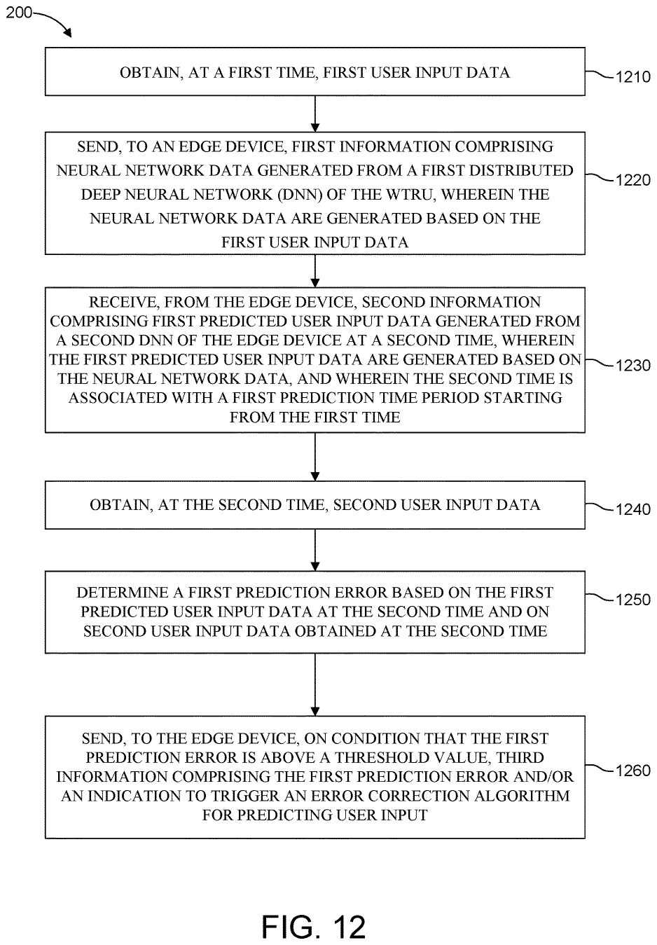

FIG. 12 is a flowchart illustrating an exemplary procedure 1200 implemented by a WTRU 102.

According to embodiments, the WTRU 102 may be configured to obtain, at a first time, first user input data (1210).

According to embodiments, the WTRU 102 may be configured to send, to an edge device, first information comprising neural network data generated from a first distributed deep neural network (DNN) of the WTRU, wherein the neural network data are generated based on the first user input data (1220).

According to embodiments, the WTRU 102 may be configured to receive, from the edge device, second information comprising first predicted user input data generated from a second DNN of the edge device at a second time, wherein the first predicted user input data are generated based on the neural network data, and wherein the second time is associated with a first prediction time period starting from the first time (1230).

According to embodiments, the WTRU 102 may be configured to obtain, at the second time, second user input data (1240).

According to embodiments, the WTRU 102 may be configured to determine a first prediction error based on the first predicted user input data at the second time and on second user input data obtained at the second time (1250).

According to embodiments, the WTRU 102 may be configured to send, to the edge device, on condition that the first prediction error is above a threshold value, third information comprising the first prediction error and/or an indication to trigger an error correction algorithm for predicting user input (1260).

According to embodiments, the WTRU 102 may be configured to determine a second prediction error based on second predicted user input data predicted at a third time and third user input obtained at the third time; and receive, from the edge device, fourth information comprising a second prediction time period, wherein the second prediction time period is shorter than the first prediction time period, and wherein the fourth information is received on condition that the second prediction error is above the threshold value.

According to embodiments, the WTRU 102 may be configured to determine a third prediction error based on third predicted user input data predicted at a fourth time and fourth user input obtained at the fourth time; send, to the edge device, on condition that the third prediction error is above the threshold value, fifth information comprising a fifth time for retraining the first DNN and/or the second DNN; receive, from the edge device, an acknowledgement message for retraining the first DNN and/or the second DNN at the fifth time; and retrain the first DNN and/or the second DNN at the fifth time.

According to embodiments, any of: the first information, the second information, the third information, and the fourth information use a session description protocol (SDP).

According to embodiments, any of: the first information, the second information, the third information, and the fourth information are mapped to SDP offer procedure capability negotiation parameters.

According to embodiments, any of: the first information, the second information, the third information, and the fourth information use a session initiation protocol update function.

According to embodiments, the error correction algorithm comprises any of a: (1) Kalman Filtering, (2) partial cube rendering, (3) depth map rendering.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
obtaining, at a first time, first user input data;
sending, to an edge device, first information comprising neural network data generated from a first deep neural network (DNN) of the WTRU, wherein the neural network data are generated based on the first user input data;
receiving, from the edge device, second information comprising first predicted user input data generated from a second DNN of the edge device at a second time, wherein the first predicted user input data are generated based on the neural network data, and wherein the second time is associated with a first prediction time period starting from the first time;
obtaining, at the second time, second user input data;
determining a first prediction error based on the first predicted user input data at the second time and on the second user input data obtained at the second time; and
sending, to the edge device, on condition that the first prediction error is above a threshold value, third information comprising the first prediction error and/or an indication to trigger an error correction algorithm for predicting user input.

2. The method according to claim 1, comprising:
determining a second prediction error based on second predicted user input data predicted at a third time and third user input obtained at the third time; and
receiving, from the edge device, fourth information comprising a second prediction time period, wherein the second prediction time period is shorter than the first prediction time period, and wherein the fourth information is received on condition that the second prediction error is above the threshold value.

3. The method according to claim 1, further comprising:
determining a third prediction error based on third predicted user input data predicted at a fourth time and fourth user input obtained at the fourth time;
sending, to the edge device, on condition that the third prediction error is above the threshold value, fifth information comprising a fifth time for retraining the first DNN and/or the second DNN;
receiving, from the edge device, an acknowledgement message for retraining the first DNN and/or the second DNN at the fifth time; and
retraining the first DNN and/or the second DNN at the fifth time.

4. The method according to claim 2, wherein any of: the first information, the second information, the third information, and the fourth information use a session description protocol (SDP).

5. The method according to claim 4, wherein any of: the first information, the second information, the third information, and the fourth information are mapped to SDP offer procedure capability negotiation parameters.

6. The method according to claim 2, wherein any of: the first information, the second information, the third information, and the fourth information use a session initiation protocol update function.

7. The method according to claim 1, wherein the error correction algorithm comprises any of a: (1) Kalman Filtering, (2) partial cube rendering, (3) depth map rendering.

8. A wireless transmit/receive unit (WTRU) comprising a processor, a transmitter, a receiver, and memory, the WTRU configured to:
obtain, at a first time, first user input data;
send, to an edge device, first information comprising neural network data generated from a first deep neural network (DNN) of the WTRU, wherein the neural network data are generated based on the first user input data;
receive, from the edge device, second information comprising first predicted user input data generated from a second DNN of the edge device at a second time, wherein the first predicted user input data are generated based on the neural network data, and wherein the second time is associated with a first prediction time period starting from the first time;
obtain, at the second time, second user input data;
determine a first prediction error based on the first predicted user input data at the second time and on the second user input data obtained at the second time; and
send, to the edge device, on condition that the first prediction error is above a threshold value, third information comprising the first prediction error and/or an indication to trigger an error correction algorithm for predicting user input.

9. The WTRU according to claim 8, configured to:
determine a second prediction error based on second predicted user input data predicted at a third time and third user input obtained at the third time; and
receive, from the edge device, fourth information comprising a second prediction time period, wherein the second prediction time period is shorter than the first prediction time period, and wherein the fourth information is received on condition that the second prediction error is above the threshold value.

10. The WTRU according to claim 8, configured to:
determine a third prediction error based on third predicted user input data predicted at a fourth time and fourth user input obtained at the fourth time;
send, to the edge device, on condition that the third prediction error is above the threshold value, fifth information comprising a fifth time for retraining the first DNN and/or the second DNN;
receive, from the edge device, an acknowledgement message for retraining the first DNN and/or the second DNN at the fifth time; and
retrain the first DNN and/or the second DNN at the fifth time.

11. The WTRU according to claim 9, wherein any of: the first information, the second information, the third information, and the fourth information use a session description protocol (SDP).

12. The WTRU according to claim 11, wherein any of: the first information, the second information, the third information, and the fourth information are mapped to SDP offer procedure capability negotiation parameters.

13. The WTRU according to claim 9, wherein any of: the first information, the second information, the third information, and the fourth information use a session initiation protocol update function.

14. The WTRU according to claim 9, wherein the error correction algorithm comprises any of a: (1) Kalman Filtering, (2) partial cube rendering, (3) depth map rendering.
